(19) United States
(12) Patent Application Publication
(10) Pub. No.: US 2009/0255091 A1
(43) Pub. Date: Oct. 15, 2009

(54) Hinge assembly and mobile terminal having the same

(75) Inventors: Sung-Tai Jung, Suwon-si (KR); Yun-Mo Kang, Seoul (KR); Seong-Geun Kim, Suwon-si (KR); Ga-Young An, Busan (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/320,123

(22) Filed: Jan. 16, 2009

(30) Foreign Application Priority Data
Apr. 10, 2008 (KR) 10-2008-0033069
May 13, 2008 (KR) 10-2008-0043819

(51) Int. Cl. E05F 1/08

(52) U.S. Cl. 16/308

(57) ABSTRACT

A hinge assembly can include: a torsion spring; a shaft, which penetrates through the torsion spring; a bushing, coupled to one end of the torsion spring and one side of the shaft; a holder, which is coupled to the other end of the torsion spring; a housing coupled to the holder; and a damper, which is coupled to the shaft, and which may dampen a rotation speed of the shaft. The damper can include: a first case, which is coupled to the shaft to move in linkage with the shaft; a second case, rotatably coupled to the first case; a viscous fluid, placed between the first case and the second case; and a stopper, which is coupled to the housing and configured to restrict the rotation angle of the second case. Thus, a mobile terminal may be unfolded automatically using a few number of parts without requiring energy consumption.

### CROSS-REFERENCE TO RELATED APPLICATIONS

This application claims the benefit of Korean Patent Applications No. 10-2008-0033069 and No. 10-2008-0043819 filed with the Korean Intellectual Property Office on Apr. 10, 2008 and May 13, 2008, respectively. The disclosures of these applications are incorporated herein by reference in their entirety.

### BACKGROUND

1. Technical Field

The present invention relates to a hinge assembly and a mobile terminal equipped with the hinge assembly.

2. Description of the Related Art

The structure of a manual hinge assembly, used in a conventional folder type mobile terminal, may employ a cam and a spring such that the mobile terminal moves to an unfolded configuration if the mobile terminal is at an angle greater than a threshold value and such that the mobile terminal moves to a folded configuration if the mobile terminal is at an angle smaller than the threshold value.

Due to the use of only the cam and spring, this conventional hinge assembly may not move in smooth, soft motions, but may rather cause impact on the mobile terminal when folding and unfolding.

In addition to the hinge assembly described above, a structure may also be used in which a motor is inserted in the hinge assembly for automatic folding and/or unfolding. This structure, however, may require a degree of electrical energy consumption due to the use of the motor.

### SUMMARY

An aspect of the invention is to provide a hinge assembly and a mobile terminal equipped with the hinge assembly that can automatically unfold the mobile terminal using a few number of parts.

One aspect of the invention provides a hinge assembly that includes: a torsion spring; a shaft, which penetrates through the torsion spring; a bushing, coupled to one end of the torsion spring and to one side of the shaft; a holder, which is coupled to the other end of the torsion spring; a housing coupled to the holder; and a damper, which is coupled to the shaft, and which may dampen a rotation speed of the shaft. Here, the damper includes: a first case, which is coupled to the shaft to move in linkage with the shaft; a second case, rotatably coupled to the first case; a viscous fluid, placed between the first case and the second case; and a stopper, which is coupled to the housing and configured to restrict the rotation angle of the second case.

A cylindrical core can be formed in a center portion of the first case, where the core may protrude in the direction of the second case, while a flange can be formed in an outer side portion of the first case, with the flange surrounding the outer side of the core, separated from the core. A friction protrusion can be formed on the second case, where the friction protrusion may be inserted between the core and the flange.

A key indentation can be formed in the core, in which the shaft may be inserted and coupled.

Also, a guide indentation shaped as an arc can be formed in one surface of the second case facing the stopper, and a detent protrusion can be formed on the stopper that may be inserted into the guide indentation.

The hinge assembly described above can further include: a sliding cam, which may be coupled to the other side of the shaft to move in linkage with the shaft; a fixed cam, which may be coupled to the housing, and which may engage the sliding cam; and a compression spring, which may be positioned between the holder and the sliding cam to place the sliding cam in close contact with the fixed cam. Here, the shaft can be made to penetrate through the holder.

The cross section of the other side of the shaft can be shaped as a D-cut. A coupling portion can be formed on the sliding cam that couples with the other side of the shaft, where the cross section of a coupling portion on the sliding cam can be shaped in correspondence with the cross section of the other side of the shaft.

A holding indentation can be formed in the holder in which the compression spring may be inserted.

The housing can cover the torsion spring, the shaft, the holder, the sliding cam, the fixed cam, the compression spring, and the damper.

Another aspect of the invention provides a mobile terminal that includes: a base unit; a folder unit, which is rotatably coupled to the base unit; and a hinge assembly, interposed between the base unit and the folder unit to rotatably couple the base unit and the folder unit. Here, the hinge assembly can include: a torsion spring; a shaft, which penetrates through the torsion spring; a bushing, coupled to one end of the torsion spring and to one side of the shaft; a holder, which is coupled to the other end of the torsion spring; a housing coupled to the holder; and a damper, which is coupled to the shaft, and which may dampen a rotation speed of the shaft. The damper includes: a first case, which is coupled to the shaft to move in linkage with the shaft; a second case, rotatably coupled to the first case, a viscous fluid, placed between the first case and the second case; and a stopper, which is coupled to the housing and configured to restrict the rotation angle of the second case.

The first case can include a cylindrical core and a flange, where the core can be formed in a center portion of the first case protruding in the direction of the second case, and the flange can be formed in an outer side portion of the first case, with the flange surrounding the outer side of the core, separated from the core. The second case can include a friction protrusion, where the friction protrusion may be inserted between the core and the flange.

A key indentation can be formed in the core, in which the shaft may be inserted and coupled.

Also, a guide indentation shaped as an arc can be formed in one surface of the second case facing the stopper, and a detent protrusion can be formed on the stopper that may be inserted into the guide indentation.

The hinge assembly can further include: a sliding cam, which may be coupled to the other side of the shaft to move in linkage with the shaft; a fixed cam, which may be coupled to the housing, and which may engage the sliding cam; and a compression spring, which may be positioned between the holder and the sliding cam to place the sliding cam in close contact with the fixed cam. The shaft can penetrate through the holder.

The cross section of the other side of the shaft can be shaped as a D-cut. A coupling portion can be formed on the sliding cam that couples with the other side of the shaft, where the cross section of a coupling portion on the sliding cam can be shaped in correspondence with the cross section of the other side of the shaft.

A holding indentation can be formed in the holder in which the compression spring may be inserted.

The housing can cover the torsion spring, the shaft, the holder, the sliding cam, the fixed cam, the compression spring, and the damper.

The base unit of the mobile terminal can be coupled to either one of the housing and the bushing, while the folder unit can be coupled to the other of the housing and the bushing.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a perspective view of a mobile terminal having a hinge assembly according to an embodiment of the invention.

FIG. 2 is a front view of a hinge assembly according to an embodiment of the invention.

FIG. 3 is an exploded perspective view of a hinge assembly according to an embodiment of the invention.

FIG. 4 and FIG. 5 are exploded perspective views of a damper in a hinge assembly according to an embodiment of the invention.

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

While such terms as “first” and “second,” etc., may be used to describe various elements, such elements must not be limited to the above terms. The above terms are used only to distinguish one element from another.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added.

The hinge assembly and mobile terminal equipped with a hinge assembly according to certain embodiments of the invention will be described below in more detail with reference to the accompanying drawings. Those elements that are the same or are in correspondence are rendered the same reference numeral regardless of the figure number, and redundant explanations are omitted.

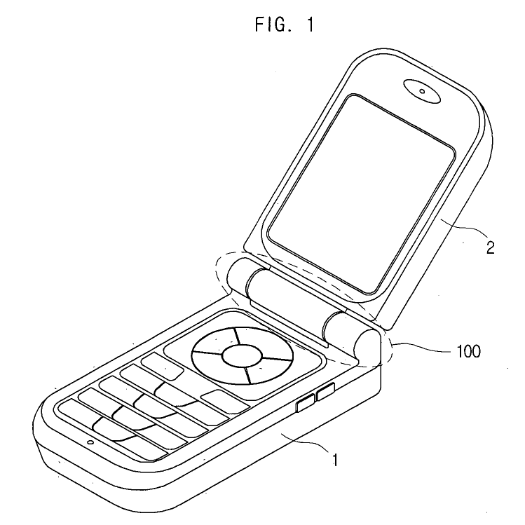

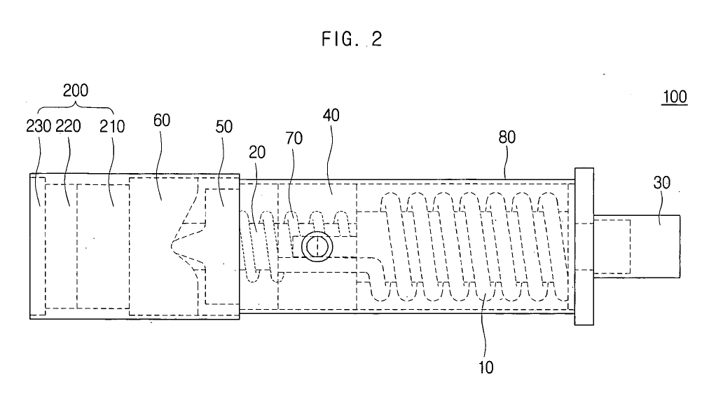

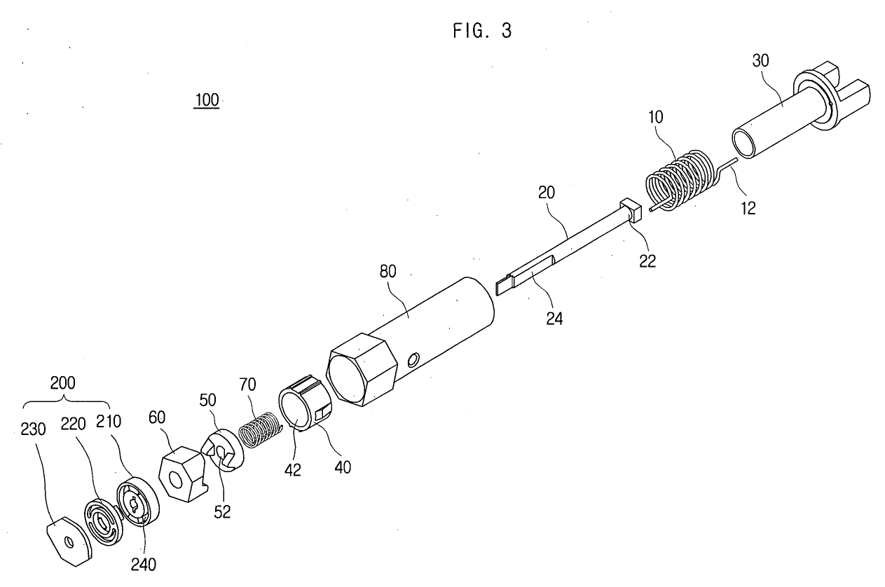

FIG. 1 is a perspective view of a mobile terminal having a hinge assembly according to an embodiment of the invention, FIG. 2 is a front view of a hinge assembly according to an embodiment of the invention, and FIG. 3 is an exploded perspective view of a hinge assembly according to an embodiment of the invention. In FIGS. 1 to 3, there are illustrated a base unit 1, a folder unit 2, a torsion spring 10, one end 12-of the torsion spring, the other end 14 of the torsion spring, a shaft 20, one side 22 of the shaft, the other side 24 of the shaft, a bushing 30, a holder 40, a holding indentation 42, a sliding cam 50, a coupling portion 52 of the sliding cam, a fixed cam 60, a compression spring 70, a housing 80, a hinge assembly 100, and a damper 200.

An embodiment of the invention provides a hinge assembly 100 and a mobile terminal equipped with the hinge assembly. The hinge assembly 100 can include a torsion spring 10, which may provide the force for unfolding the folder type mobile terminal; a shaft 20, which may penetrate the internal space of the torsion spring; a bushing 30, which may be coupled to one end 12 of the torsion spring and one side 22 of the shaft; a holder 40, which may be coupled to the other end 14 of the torsion spring, and through which the shaft may penetrate; a sliding cam 50, which may be coupled to the other side 24 of the shaft to move in linkage with the shaft; a fixed cam 60, which may face and touch the sliding cam; a compression spring 70, which may be interposed between the holder and the sliding cam; a housing 80, which may be coupled to the holder and the fixed cam; and a damper 200, which may dampen the rotation speed of the shaft.

According to this embodiment, the hinge assembly 100 can be interposed between a base unit 1 and a folder unit 2 of a mobile terminal to rotatably couple the base unit 1 With the folder unit 2, as illustrated FIG. 1. The torsion spring 10 of the hinge assembly may provide an elastic rotation force to unfold the folder type mobile terminal from a folded state.

When the base unit 1 and the folder unit 2 are in a folded state, the torsion spring 10 may retain elastic torsion energy, which may be used to unfold the mobile terminal. A mobile terminal having a hinge assembly 100 according to an embodiment of the invention may be kept folded by a magnetic attaching member or detent member that applies a force greater than the elastic force of the torsion spring. Then, when the force of the magnetic attaching member or detent member keeping the base unit 1 and the folder unit 2 folded is removed, the mobile terminal may be automatically unfolded by the torsion spring.

That is, in a mobile terminal equipped with a hinge assembly 100 according to an embodiment of the invention, the base unit and folder unit may, from a folded state, be automatically unfolded by the elastic force of the torsion spring 10.

The torsion spring 10 can have a helical shape, as illustrated in FIGS. 2 and 3, and can be an elastic member that asserts a restoring force against twisting. The hinge assembly 100 may provide rotation in a particular direction using the elastic restoring force of the torsion spring, at which the base unit 1 and the folder unit 2 of the mobile terminal coupled by the hinge assembly may be automatically unfolded from a folded state.

The shaft 20 can penetrate through the torsion spring 10, and one side of the shaft 20 can be coupled to the bushing 30 such that the shaft 20 may move in linkage with the bushing 30. The shaft may correspond to the axis about which the hinge assembly 100 provides rotation. The shaft penetrating the torsion spring can also penetrate the holder 40 and can be coupled with the sliding cam 50 and the bushing 30 such that the shaft may move in linkage with the sliding cam 50 and the busing 30.

One end 12 of the torsion spring 10 can be coupled to the bushing 30, which may be coupled to one side 22 of the shaft 20. That is, with one end of the torsion spring coupled to the bushing, the torsion spring can provide a torsional elastic force to the bushing and the shaft. As the torsion spring, which may have one end coupled to and supported by the bushing, is twisted beyond its basic shape, the torsion spring may provide a torsional elastic force (torque).

Also, one side 22 of the shaft can be coupled to the bushing 30. According to this particular embodiment, the shaft 20 and the bushing can be coupled to each other for linked movement.

The shaft 20 can also penetrate the holder 40, and the other end 14 of the torsion spring 10 can be coupled to the shaft 20. Although the shaft may penetrate the holder, it may not move in linkage with the holder. That is, due to the torsion spring that has one end coupled to the bushing 30 and the other end coupled to the holder 40, the bushing and the shaft can be made to rotate in relative movement-to the holder.

The sliding cam 50 can be coupled to the other side 24 of the shaft penetrating the holder 40. The sliding cam 50 can be coupled to the other side of the shaft, in order that the sliding cam may rotate in linkage with the shaft 20. On the sliding cam, there may be a coupling portion formed, to which the other side of the shaft can be coupled. The other side 24 of the shaft that is inserted through the coupling portion 52 of the sliding cam can have a cross section shaped as a D-cut, while the cross section of the coupling portion 52 of the sliding cam can be shaped in a D-cut in correspondence with the cross section of the other side 24 of the shaft. In this way, the sliding cam 50 and the shaft 20 can be made to move in linkage.

The fixed cam 60 can be positioned facing and touching the sliding cam 50. That is, the fixed cam can engage the sliding cam. The fixed cam can be placed in close contact with the sliding cam, which may move in linkage with the shaft 20. Thus, as described later in more detail, the fixed cam may control the rotation speed of the sliding cam and may thereby dampen the rotation of the shaft and the bushing.

The compression spring 70 can be positioned between the holder 40 and the sliding cam 50. A holding indentation 42 can be formed in the holder in which a portion of the compression spring may be inserted, so that the compression spring may be supported by the holding indentation of the holder to elastically push the sliding cam. In this way, the sliding cam can be placed in close contact with the fixed cam 60. As the sliding cam is put in close contact with the fixed cam, the sliding cam and the fixed cam may engage each other with greater reliability.

The housing 80 can be coupled with the fixed cam 60, the holder 40, and the stopper 230 of the damper 200, which may not move in linkage with the shaft 20. The housing can secure the fixed cam 60, the holder, and the stopper 230 inside, and can hold the sliding cam 50, shaft 20, compression spring 70, and torsion spring 10. In other words, according to this embodiment, the housing may cover the torsion spring, shaft, holder, sliding cam, fixed cam, compression spring 70, and damper. That is, the fixed cam, the holder, and the stopper 230 of the damper may be covered secured to the housing 80, while the sliding cam, the shaft, the torsion spring, and the first and second cases 210, 220 of the damper may be covered inside the housing in a manner that allows rotation.

According to this particular embodiment, the bushing 30 coupled to the one side 22 of the shaft may be exposed outside the housing 80.

The hinge assembly 100 according to this embodiment can be structured such that the sliding cam 50, shaft, and bushing 30 may be rotated by the elastic force of the torsion spring 10 in an opposite direction to the housing 80, fixed cam 60, and holder 40.

As set forth above, a hinge assembly 100 according to an embodiment of the invention can be employed in coupling the base unit 1 and the folder unit 2 of a mobile terminal, to provide a mobile terminal that can be automatically unfolded without using a motor.

As illustrated in FIG. 1, a hinge 100 structure according to this embodiment can be applied to a mobile terminal that includes a base unit 1, which may contain a board mounted with various electronic components, and which may include a keypad, etc.; a folder unit 2, which may be coupled to the base unit 1 in a manner that allows folding, and which may be unfolded by rotation; and a hinge assembly, which may be interposed between the base unit 1 and the folder unit 2 to rotatably couple the base unit 1 and folder unit 2 to each other.

A mobile terminal apparatus equipped with a hinge assembly 100 according to an embodiment of the invention may thus be automatically unfolded without using a motor that requires electrical energy. Moreover, the hinge assembly based on this embodiment may provide a longer life span than does a hinge structure that requires a motor.

When the mobile terminal is folded, the torsion spring 10 may be torsionally deformed and may retain a torsional elastic restoring force in a direction that unfolds the base unit 1 and folder unit 2 of the mobile terminal. As the force of the magnetic attaching member or detent member keeping the base unit 1 and the folder unit 2 folded is removed, the bushing 30 and the housing 80 of the hinge assembly may rotate in opposite directions. In this way, the base unit 1 and the folder unit 2 each coupled to one and the other of the bushing and the housing may be unfolded.

According to this embodiment, the sliding cam 50, shaft 20, and bushing 30 can be rotated by the torsional elastic force of the torsion spring 10 in an opposite direction to the holder 40, fixed cam 60, and housing 80. Therefore, with the base unit 1 coupled to the housing, for example, and the folder unit 2 coupled to the bushing, the mobile terminal may be automatically unfolded. In other words, the base unit 1 and the folder unit 2 can be coupled to elements of the hinge assembly 100 that are rotated by the torsion spring 10 in different directions, to rotate together with the rotation of the hinge assembly.

According to the internal structure by which the base unit 1 and the folder unit 2 are coupled, the base unit 1 may be coupled to the bushing 30, and the folder unit 2 may be coupled to the housing 80.

The fixed cam 60, which may be coupled to the housing, can engage the sliding cam 50, which may be in linkage with the shaft 20. A tapering protrusion can be formed on the sliding cam, while a tapering depression can be formed in the fixed cam, so that the sliding cam may mate with the fixed cam. The shapes of the sliding cam and fixed cam described above may vary according to the demands of the user. With the fixed cam facing and maintaining contact with the sliding cam, which may undergo a relative rotating motion, the fixed cam may provide a damping force to the rotation of the sliding cam. The amount of damping force applied to the rotating motion of the hinge assembly can be adjusted according to the shape and structure of the interlocking fixed cam and sliding cam.

The fixed cam 60 and the sliding cam 50 may dampen the rotating speed of the elements of the hinge assembly 100. The rotation speed of the bushing 30 relative to the housing 80 may reach its maximum when the restoring force of the torsion spring 10 becomes 0, but this rotating speed can be dampened by the damping function provided by the sliding cam engaging the fixed cam.

The sliding cam 50, the shaft 20 moving in linkage with the sliding cam, and the bushing 30 coupled to the shaft can be rotated by the torsion spring 10 relative to the housing 80, where the rotation speed can be dampened by the fixed cam 60.

According to an embodiment of the invention, when the restoring force of the torsion spring 10 unfolds the base unit and the folder unit, which may each be coupled to one and the other of the bushing 30 and the housing 80, the damping function of the fixed cam 60 and the sliding cam 50 may be implemented. Therefore, the mobile terminal can be unfolded smoothly, without receiving an impact at the maximum unfolding position.

In order to smoothly adjust the speed by which the mobile terminal may be unfolded, a reliable mating may be provided between the fixed cam 60 and the sliding cam 50. According to an embodiment of the invention, the compression spring 70 interposed between the holder 40 and the sliding cam can be supported by the holder to continuously apply an elastic force onto the sliding cam. Thus, the sliding cam can be placed in close contact with the fixed cam 60 by the compression spring continuously, to thereby implement the hinge assembly 100 with a reliable damping function.

A hinge assembly 100 based on this embodiment can thus be utilized to automatically unfold a motor terminal, without using a motor that requires electrical energy consumption, and to implement a smooth unfolding motion for the mobile terminal.

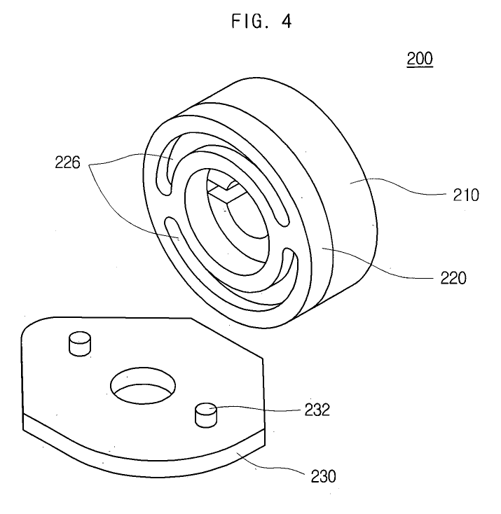

Also, according to this embodiment, a damper 200 can be coupled to the shaft, as illustrated in FIGS. 2 and 4, to dampen the rotation speed of the shaft and provide a smoother unfolding motion for the mobile terminal. In this particular embodiment, the other side of the shaft can penetrate through the sliding cam and the fixed cam to be coupled with the damper.

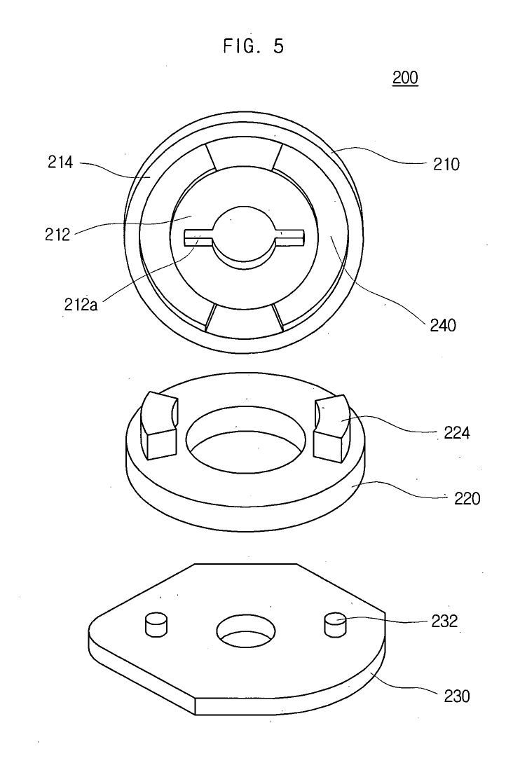

FIG. 4 and FIG. 5 are exploded perspective views of a damper in a hinge assembly according to an embodiment of the invention. A description will be provided as follows, with reference to. FIGS. 4 and 5, for the damper 200 of a hinge assembly according to an embodiment of the invention.

According to an embodiment of the invention, the damper 200 can include a first case 210, a second case 220 coupled to the first case in a manner that allows sliding and rotating, and a stopper 230 positioned adjacent to the second case to restrict the rotation of the second case, as illustrated in FIGS. 4 and 5.

A viscous fluid can be filled in the internal space between the first case 210 and the second case 220. The viscous fluid can be injected between the first case 210 and the second case 220 to provide friction onto the relative movement of the first case and second case. The viscous fluid can be injected between the first case and the second case and sealed. The viscous fluid can be a fluid that has a high level of viscosity, capable of dampening the rotation speed of the shaft by applying friction to the relative rotation of the first case and second case. As such, a high-viscosity grease or silicone oil can be used for the viscous fluid.

The first case 210 can be coupled with the shaft, which may penetrate the sliding cam and the fixed cam, so that the first case 210 may move in linkage with the shaft. According to this embodiment, the cross section at the end portion of the other side of the shaft that penetrates the sliding cam and the fixed cam can be shaped as a rectangle or a symmetrical D-cut form. As illustrated in FIG. 3, the end portion of the shaft's other side that may be coupled with the damper 200 can have a shape similar to that obtained when the portions of the cylindrical shaft are cut off from the sides symmetrically.

As in the example shown in FIG. 5, the first case 210 can include a core 212 and a flange 214, with an internal space interposed between the core and the flange.

The core 212 can have a cylindrical shape protruding from a center portion of the first case in the direction of the second case. The core can be placed in close contact with the second case 220, but in a manner that allows slipping. Key indentations 212a can be formed in the core that may be used for coupling with the shaft. The key indentations 212a can be formed in correspondence with the rectangular or symmetrical D-cut shape of the shaft's cross section. In this particular embodiment, the shaft can be inserted and coupled in the key indentations having a quadrilateral shape, so that the first case 210 may move in linkage with the shaft.

The flange 214 can be formed on an outer side portion of the first case 210, in a position surrounding the core 212. The flange 214 can protrude out towards the second case 220 from the edge of the first case separated by a particular distance from the core. As in the example shown in FIG. 5, an internal space 240 can be formed between the core and the flange in which a viscous fluid may be injected.

The flange 214 can be in close contact with an edge or an outer side portion of the second case 220, in a manner that allows slipping. The flange and the core 212 of the first case 210 can be placed in close contact with the second case, to thereby seal the viscous fluid. A ring of silicone can be placed between the first case and the second case to prevent the viscous fluid from leaking.

Also, friction protrusions 224 can be formed on the second case 220, protruding in the direction of the first case 210. The friction protrusions 224 can be formed in positions that allow the friction protrusions 224 to be inserted in the internal space defined by the core 212 and the flange 214. With the friction protrusions inserted in the space between the core and the flange into which the viscous fluid may be injected, a larger frictional force can be applied by the viscous fluid on the second case.

The first case 210 and the second case 220 can be coupled such that the first and second cases 210, 220 can slip and rotate in relation to each other. At the same time, the viscous fluid can be sealed in the internal space formed by the first case and second case, while friction protrusions 224 can be formed on the second case, so that the second case 220 may move in linkage with the first case, due to the friction applied by the viscous fluid, unless a particular external force is added. In other words, the rotation of the shaft coupled to the first case can cause the second case 220 to also rotate.

A stopper 230, by which the second case 220 rotating together with the first case 210 may be stopped from rotating in a particular region, can be coupled to the housing. The stopper secured to the housing can stop the rotation of the second case at a particular range of angles.

According to this embodiment, the second case 220 and the stopper 230 can be coupled in a manner that allows slipping. As in the example shown in FIG. 4, guide indentations 226 can be formed in one surface of the second case that faces and touches the stopper. A guide indentation can be a concave indentation formed in one surface of the second case and can be shaped as an arc forming a particular angle about the center, when seen from the one surface of the second case. The arc-shaped guide indentations 226 may be formed in the surface of the second case in symmetry.

Conversely, detent protrusions 232 can be formed on one surface of the stopper 230 facing the second case 220. The detent protrusions can be formed in positions corresponding to the positions of the guide indentations 226, such that the detent protrusions may be inserted in the guide indentations. There may be two detent protrusions, each of which may be inserted in the symmetrically formed guide indentations 226, as illustrated in FIG. 4.

Thus, the second case 220 can be restrained from rotating together with the shaft and the first case 210 at certain angles, due to the stopper 230 on which the detent protrusions 232 may be formed. As the detent protrusions may be inserted in the guide indentation 226 of the second case 220, and the stopper 230, on which the detent protrusions 232 are formed, may be secured to the housing, the second case can rotate within the particular range defined by the guide indentations.

In the particular region in which the rotation of the second case 220 is restricted, the first case 210 and the second case may rotate relatively to each other. If the first case is rotated while the second case is still, the first case may continuously receive the friction applied by the viscous fluid. Thus, during the period when the second case is restrained by the stopper 230 from rotating, the rotating speed of the shaft can be dampened.

If, on the other hand, the shaft and the first case 210 rotate in the opposite direction, the second case 220 may again move in linkage with the first case and the shaft, until it reaches a particular angle, at which the rotation of the second case may again be stopped by the stopper 230. As such, the function of the damper 200 can be implemented in the opposite direction beyond the point at which the rotation of the second case is stopped.

According to an embodiment of the invention, the rotation speed of the shaft can be dampened in a particular region in which the shaft may rotate. The rotation speed of the shaft may be dampened in a particular region where the rotation of the second case 220 is restricted by the stopper 230. Thus, by modifying the guide indentations 226 formed in the second case, the region in which the damping function is implemented can be adjusted. That is, by modifying the angle formed by both ends of each guide indentation 226 about the center portion of the second case, the region in which the second case may rotate without being restricted by the stopper 230 can be adjusted.

As set forth above, the shaft can be coupled to the damper 200, and the damper can dampen the rotating speed of the shaft at certain angles at which the shaft may be rotating. Thus, in a mobile terminal equipped with a hinge assembly based on certain embodiments of the invention, the folder unit can be unfolded smoothly, without having the elastic energy cause an impact at the maximum unfolding angle.

According to certain embodiments of the invention as set forth above, by utilizing a torsion spring in the hinge assembly structure, a mobile terminal can be made to unfold automatically in a smooth movement using just a few number of parts.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

Many embodiments other than those set forth above can be found in the appended claims.

What is claimed is:

1. A hinge assembly comprising:
a torsion spring;
a shaft penetrating through the torsion spring;
a bushing coupled to one end of the torsion spring and coupled to one side of the shaft;
a holder coupled to the other end of the torsion spring;
a housing coupled to the holder; and
a damper coupled to the shaft and configured to dampen a rotation speed of the shaft, the damper comprising:
a first case coupled to the shaft and configured to move in linkage with the shaft;
a second case rotatably coupled to the first case;
a viscous fluid interposed between the first case and the second case; and
a stopper coupled to the housing and configured to restrict a rotation angle of the second case.

2. The hinge assembly of claim 1, wherein the first case comprises:
a cylindrical core formed in a center portion of the first case and protruding in a direction-of the second case; and
a flange formed in an outer side portion of the first case, the flange separated from the core and surrounding an outer side of the core, and
the second case comprises a friction protrusion formed thereon, the friction protrusion inserted between the core and the flange.

3. The hinge assembly of claim 2, wherein the core comprises a key indentation formed therein, the shaft inserted and coupled in the key indentation.

4. The hinge assembly of claim 1, wherein the second case comprises a guide indentation formed in one surface thereof facing the stopper, the guide indentation shaped as an arc, and
the stopper comprises a detent protrusion formed thereon, the detent protrusion inserted into the guide indentation.

5. The hinge assembly of claim 1, further comprising:
a sliding cam coupled to the other side of the shaft and configured to move in linkage with the shaft;
a fixed cam coupled to the housing and engaging the sliding cam; and
a compression spring interposed between the holder and the sliding cam and configured to place the sliding cam in close contact with the fixed cam, wherein
the shaft penetrates through the holder.

6. The hinge assembly of claim 5, wherein the other side of the shaft has a D-cut shaped cross section,
the sliding cam comprises a coupling portion, the coupling portion coupled to the other side of the shaft, and
the sliding cam has a cross section at the coupling portion shaped in correspondence with the cross section of the other side of the shaft.

7. The hinge assembly of claim 5, wherein the holder comprises a holding indentation formed therein, the compression spring inserted in the holding indentation.

8. The hinge assembly of claim 5, wherein the housing is configured to cover the torsion spring, the shaft, the holder, the sliding cam, the fixed cam, the compression spring, and the damper.

9. A mobile terminal comprising:
a base unit;
a folder unit rotatably coupled to the base unit; and
a hinge assembly interposed -between the base unit and the folder unit and configured to rotatably couple the base unit and the folder unit, wherein the hinge assembly comprises:
a torsion spring;
a shaft penetrating through the torsion spring;
a bushing coupled to one end of the torsion spring and coupled to one side of the shaft;
a holder coupled to the other end of the torsion spring;
a housing coupled to the holder; and
a damper coupled to the shaft and configured to dampen a rotation speed of the shaft, the damper comprising:
a first case coupled to the shaft and configured to move in linkage with the shaft;
a second case rotatably coupled to the first case;
a viscous fluid interposed between the first case and the second case; and
a stopper coupled to the housing and configured to restrict a rotation angle of the second case.

10. The mobile terminal of claim 9, wherein the first case comprises:
a cylindrical core formed in a center portion of the first case and protruding in a direction of the second case; and
a flange formed in an outer side portion of the first case, the flange separated from the core and surrounding an outer side of the core, and
the second case comprises a friction protrusion formed thereon, the friction protrusion inserted between the core and the flange.

11. The mobile terminal of claim 10, wherein the core comprises a key indentation formed therein, the shaft inserted and coupled in the key indentation.

12. The mobile terminal of claim 9, wherein the second case comprises a guide indentation formed in one surface thereof facing the stopper, the guide indentation shaped as an arc, and
the stopper comprises a detent protrusion formed thereon, the detent protrusion inserted into the guide indentation.

13. The mobile terminal of claim 9, wherein the hinge assembly comprises:
a sliding cam coupled to the other side of the shaft and configured to move in linkage with the shaft;
a fixed cam coupled to the housing and engaging the sliding cam; and
a compression spring interposed between the holder and the sliding cam and configured to place the sliding cam in close contact with the fixed cam, and the shaft penetrates through the holder.

14. The mobile terminal of claim 13, wherein the other side of the shaft has a D-cut shaped cross section,
the sliding cam comprises a coupling portion, the coupling portion coupled to the other side of the shaft, and
the sliding cam has a cross section at the coupling portion shaped in correspondence with the cross section of the other side of the shaft.

15. The mobile terminal of claim 13, wherein the holder comprises a holding indentation formed therein, the compression spring inserted in the holding indentation.

16. The mobile terminal of claim 13, wherein the housing is configured to cover the torsion spring, the shaft, the holder, the sliding cam, the fixed cam, the compression spring, and the damper.

17. The mobile terminal of claim 9, wherein the base unit is coupled to one of the housing and the bushing, and
the folder unit is coupled to the other of the housing and the bushing.
